(19) United States
(12) Patent Application Publication
(10) Pub. No.: US 2010/0251654 A1
(43) Pub. Date: Oct. 7, 2010

(54) Door Insulating Blanket

(76) Inventor: James W. Paul, Acme, PA (US)

Correspondence Address: GLOBAL PATENTS/RANDY W. TUNG, ESQ, 838 W. LONG LAKE, SUITE 120, BLOOMFIELD HILLS, MI, 48302, US

(21) Appl. No.: 12/417,167

(22) Filed: Apr. 2, 2009

(51) Int. Cl. E06B 3/30

(52) U.S. Cl. 52/506.05

(57) ABSTRACT

A door insulating blanket constructed of a blanket body that has a minimum thickness of ¼ inch and a dimension not larger than a planar area of a door; a slot opening in the blanket body disposed in a longitudinal direction of a door handle in the door; and a plurality of metal buttons that has magnetic properties provided along an outer peripheral edge on a surface facing the door of the blanket body, each of the plurality of metal buttons being spaced from an adjacent metal button by a distance not larger than 5 inches.

### FIELD OF THE INVENTION

The present invention generally relates to a household item and more particularly, relates to a door insulating blanket for use on a metal entry door.

### BACKGROUND OF THE INVENTION

Metal entry doors are frequently used in buildings of both commercial and residential nature. The metal entry doors tend to transmit either low temperature or high temperature from the outside environment into a building. For instance, in cold weather, a metal entry door is cold to the touch and therefore provides discomfort for the people who operates such doors. A door insulating blanket is therefore desirable for insulating such metal entry doors from an indoor environment for both comfort and energy conservation reasons. Moreover, a door insulating blanket may further provide the benefit of sound insulation and therefore providing a quieter environment for the person occupying such space inside the metal entry door.

It is therefore an object of the present invention to provide a door insulating blanket that can be used on a metal entry door for temperature insulation.

It is a further object of the present invention to provide a door insulating blanket to be installed on a metal entry door to provide improved sound insulation.

### SUMMARY OF THE INVENTION

In accordance with the present invention, a door insulating blanket for use on a metal entry door is advantageously provided.

In a preferred embodiment, the present invention door insulating blanket can be constructed of a blanket body that has a minimum thickness of ¼ inch and a dimension not larger than a planar area of a door; a slot opening in the blanket body disposed in a longitudinal direction of a door handle in the door; and a plurality of metal buttons that has magnetic properties provided along an outer peripheral edge on a surface facing the door of the blanket body, each of the plurality of metal buttons being spaced from an adjacent metal button by a distance not larger than 5 inches.

### BRIEF DESCRIPTION OF THE DRAWINGS

The invention will now be described, by way of example, with reference to the accompanying drawings, in which:

FIG. 1 is a perspective view of the present invention door insulating blanket of the present invention.

FIG. 2 is a perspective view showing the backside of the present invention door insulating blanket equipped with a plurality of magnetic buttons.

FIG. 3 is a partially exploded plane view of the present invention door insulating blanket as installed on a metal entry door.

FIG. 4 is a partial, cross-sectional view illustrating how the present invention door insulating blanket is installed on a metal door.

FIG. 5 is an alternate embodiment of the present invention door insulating blanket incorporating a peephole.

### DETAILED DESCRIPTION OF THE PREFERRED EMBODIMENT

The present invention discloses a door insulating blanket that can be advantageously used on a metal entry door for both temperature insulation and sound insulation purposes.

The present invention door insulating blanket is a device that can be used to increase the insulation value of a steel exterior door, or a steel entry door. It consists of a quilt that is made of two layers of nylon fabric with a polyester fiberfill. The present invention can be produced in 32 and 36 inch widths, as well as in a larger, 42 inch wide commercial model that is configured so as to be able to fit over lever operated openers. It is provided in a variety of colors and patters. It can also be provided in various thickness. It measures 80 inches wide and is retained in a place with a series of magnets. The present invention may also be equipped with a snap fit eyelet that can be used to provide access to a peephole.

The present invention door insulating blanket fulfills the need for a method of increasing the insulating value of a steel door. The appealing features of the present invention are its convenience, ease of installation, adaptability, and the improved insulation value it provides. The present invention can be adapted for use on most steel exterior doors and can be installed in a matter of minutes and can be easily removed when not required for cleaning purposes. In use, the added insulation it can provide can help reduce the heating and cooling costs, as well as improve the overall comfort of a structure.

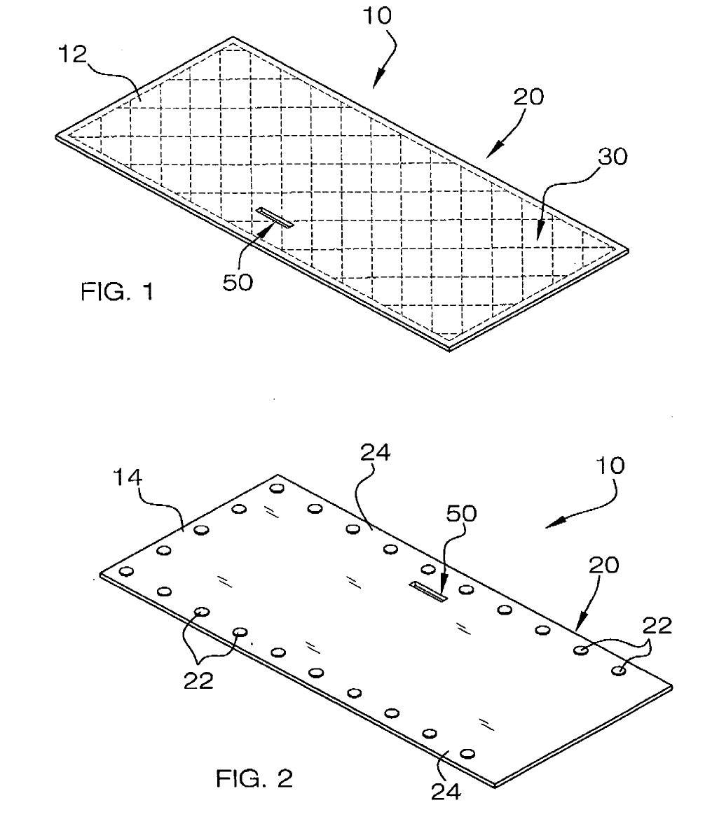

Referring initially to FIG. 1, wherein a present invention door insulating blanket 10 is shown in a perspective view. The perspective view in FIG. 1 illustrates the front side 12 of the door insulating blanket 10, while a perspective view in FIG. 2 illustrates the backside 14 of the door insulating blanket 10.

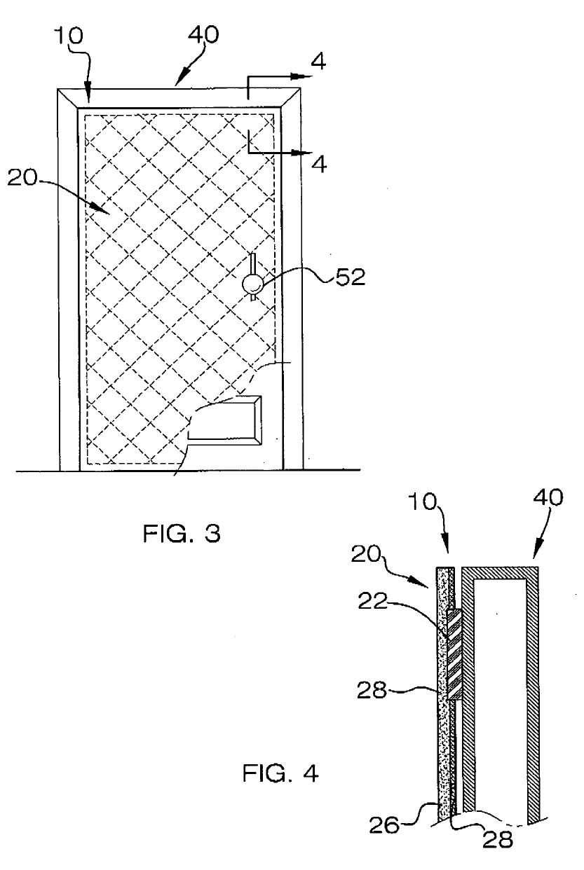

The door insulating blanket 10 is formed of a blanket body 20 that has a minimum thickness of about ¼ inch and a planar area 30 not larger than a planar area of a door 40 onto which the blanket body is installed. The door 40 is displayed in FIGS. 3, 4 and 5. The present invention door insulating blanket 10 is most beneficiary, and most efficiently used on a door 40 that is made of metal in order to achieve its maximum efficiency.

A slot opening 50 is provided in the blanket body 20 disposed in a longitudinal direction of the door 40 for the handle 42 for the door lock (not shown) to penetrate therethrough. This is shown in FIG. 3. It should be noted that the slot opening 50 may also be disposed in a transverse direction of the door 40 to accommodate other types of door handles.

The plurality of metal buttons 22 having magnetic properties is provided along an outer peripheral edge 24 of the backside 14 of the door insulating blanket 10. The magnetic buttons 22 are installed essentially on the surface, or the backside 14 of the blanket body 20, that faces the door after insulation. Each of the plurality of metal buttons 22 is spaced apart from an adjacent metal button 22 by a distance not larger than 5 inches, and preferably not larger than 3 inches, and most preferably not larger than 2 inches.

The blanket body 20 can be formed of a quilt, such as one of a multiplicity of fiberfill 26 (shown in FIG. 4) that is contained in between two fabric panels 28. The fabric panel may be suitably selected from any fabric materials. A few of such suitable fabric materials are nylon, polyester, cotton, etc. The thickens of the blanket body 20 preferably has a minimum of ½ inch.

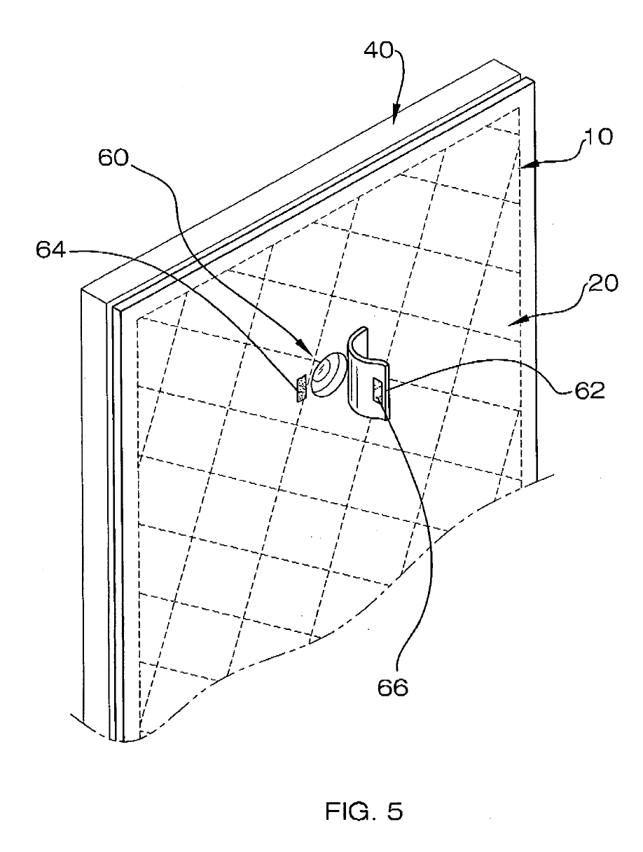

FIG. 4 illustrates the insulation by the plurality of magnetic buttons 22 of the blanket body 20 on a metal door 40. FIG. 5 shows an alternate embodiment wherein a peephole 60 is provided in the blanket body 20. The peephole 60 may be suitably covered by a piece of fabric of plastic 62 and fastened to the blanket body 20 by a hook-and-loop fastener 64, 66. For instance, the part 64 may be a hook portion while the part 66 may be a loop portion of the hook-and-loop fastener set.

The present invention has therefore been amply described in the above descriptions and in the appended drawings of FIGS. 1-5.

While the preferred embodiments of the invention have been described above, it will be recognized and understood that various modifications can be made in the invention and the appended claims are intended to cover all such modifications which may fall within the spirit and scope of the invention.

What is claimed is:

1. A door insulating blanket comprising:
a blanket body having a minimum thickness of Y inch and a planar area not larger than a planar area of a door;
a slot opening in said blanket body disposed in a longitudinal direction of a door handle in said door; and
a plurality of metal buttons having magnetic properties provided along an outer peripheral edge on a surface facing said door of said blanket body, each of said plurality of metal buttons being spaced from an adjacent metal button by a distance not larger than 5 inches.

2. The door insulating blanket according to claim 1, wherein said blanket body is a quilt.

3. The door insulating blanket according to claim 1, wherein said blanket body is a quilt formed by two fabric panels and a multiplicity of fiberfill therein between.

4. The door insulating blanket according to claim 3, wherein said two blanket panels are formed of nylon or polyester.

5. The door insulating blanket according to claim 1, wherein said blanket body having a minimum thickness of ½ inch.
